(19) United States
(12) Patent Application Publication
(10) Pub. No.: US 2008/0290660 A1
(43) Pub. Date: Nov. 27, 2008

(54) Coupling Between Two Bodies Comprising an Elastically Deformable Cutting Ring With a Screw Thread Forming Cutting Lips

(75) Inventor: Gerrit Jan De Wilde, Anerveen (NL)

Correspondence Address: Beck & Thomas, P.C.;SUITE 100, 1575 McFARLAND ROAD, PITTSBURGH, PA, 15216-1808, US

(73) Assignee: WIDEE B.V., Lutten (NL)

(21) Appl. No.: 11/994,614

(22) PCT Filed: Jul. 3, 2005
(86) PCT No.: PCT/NL2005/000472

§ 371 Date: Jul. 21, 2008

(51) Int. Cl. F16L 19/00

(52) U.S. Cl. 285/382.7

(57) ABSTRACT

The invention relates to a coupling between a first body (5) with a hole, and a cylindrical end zone of a second body (1) by means of tongues (8) which, when said end zone is arranged, scrape over the surface thereof, whereby the backward movement is blocked. The coupling has the feature that the tongues form part of an interrupted ring (3); the tongues are the windings of a helix; the tongues are inclined in the direction of arrangement; the end zone can displace along the helix during arrangement with elastic deformation of the ring; additional pressure forces occur between the tongues and the end zone when a force in opposite direction to the insertion direction is exerted between the ring and the second body; whereby, when the second body rotates relative to the first body, the helix is followed so that an axial movement also occurs and the end zone of the first body can be removed.

The invention relates to a coupling between a first body with a hole, for instance a cylindrical hole with an axis, and a cylindrical end zone of a second body to be inserted therein in an axial insertion direction, in which hole and/or on the surface of which end zone extend a number of elastically displaceable tongues connected to the relevant body, the free end edges of which tongues lie substantially on the peripheral plane of an imaginary, substantially rotation-symmetrical body, respectively the diameter of which is smaller than the outer diameter of the end zone of the second body or the diameter of which is greater than the diameter of the hole, which tongues deform elastically when said end zone is arranged and scrape over the surface thereof with their free edges such that after arranging of the end zone over some distance the movement in backward direction relative to the insertion direction is blocked.

Such a coupling is known from EP-A-0 378 035, EP-A-0 212 883, EP-A-0 579 194, EP-A-0 294 948, EP-A-0 972 981 and DE-A-197 23 594. Relative to this stated prior art it is an object of the invention to embody a coupling between two bodies such that it can be released very easily without specific uncoupling operations and the use of tools intended specifically for this purpose, while in the coupled situation the bodies are nevertheless coupled to each other very firmly and even, ostensibly, inseparably.

These and other objects are realized with a coupling of the type specified in the preamble which has the feature that the tongues form part of a ring;

the tongues are the windings of a protruding helix;

the main direction of the tongues has a substantial component in the direction of arrangement;

the protruding end edges of the tongues are defined by the side surfaces of those tongues, which side surfaces enclose an acute angle with each other;

the ring co-acts with a sleeve which is connected to the first body and defines the axial position of the ring;

the ring has an interruption wherein the end surfaces adjacent thereto are displaceable relative to each other during elastic deformation of the ring;

the helix has a diameter such that, during arranging, the end zone of the second body can be displaced along the helix only during elastic deformation of the ring, and the end edges of the tongues exert elastic pressure forces on the end zone of the second body;

the ring is locked against rotation relative to the first body by locking means; and

pressing means are present which are connected to the first body and cause additional pressure forces between the end edges of the tongues and the end zone of the second body in the case where a force in opposite direction to the insertion direction is exerted between the ring and the second body;

this such that, when the second body rotates around the axis relative to the first body, the helix is followed in that the tongues cut into the surface of the end zone, so that an axial relative movement also occurs and said end zone of the second body can be removed from the first body.

The ring consists of a material and is modelled such that when the coupling between the two bodies is effected an elastic deformation occurs in the tongues, wherein the free end edges of the tongues move in scraping manner along the relevant surface of the second body. The backward movement is blocked by said choice of the main direction of the tongues. The coupling can nevertheless be released, namely by exerting a rotation force between the two bodies, whereby the bodies are separated from each other in the manner of a screw by the plastically deforming or cutting action of the tongues formed by the helix.

The ring can consist of any suitable material. This is on condition that the material of the tongues has a sufficiently great hardness, in combination with a suitable shape, relative to the material on the relevant surface of the second body that the operation according to the invention as described in the foregoing can be realized effectively. A backward displacement through translation alone must be impossible. The backward movement must only be possible with a rotation which goes together with a translation in the manner of a helical movement.

In a determined embodiment, the coupling has the special feature that the ring consists of metal, for instance steel or aluminium.

In yet another embodiment, the coupling has the special feature that the ring consists of plastic, for instance ABS or POM. In this embodiment the ring can for instance be manufactured by injection moulding.

According to another aspect of the invention, the coupling can have the special feature that at least the said end zone of the second body consists of plastic, concrete, wood or metal, such as iron, copper or aluminium. It is important that the material of the tongues is chosen such that it can co-act effectively in the above described manner with the material of the second body.

The coupling is preferably embodied such that the pressing means comprise a substantially rotation-symmetrical pressure surface which forms part of the sleeve and co-acts with the ring, and which has a diameter varying monotonously in axial direction, for instance roughly corresponding to the shape of a truncated cone, which pressure surface elastically deforms the ring during the exertion of said force in opposite direction to the insertion direction between the ring and the second body such that the pressure forces exerted on the second body by the ribs are increased.

This embodiment has the great advantage that the operation wherein the tongues effectively braces themselves against axial displacement of the second body in backward direction is enhanced as the force in backward direction is increased.

The locking means can be embodied in any suitable manner. An embodiment is recommended in which the locking means have at least one protrusion and a recess co-acting therewith, one of which is present on the ring and the other on the sleeve.

It is often necessary for the coupling according to the invention to provide a sealing connection between the bodies to be mutually coupled.

For this purpose a coupling according to the invention can be provided with a bush which can be coupled to the sleeve by means of coupling means, and a sealing ring which is present in the transition zone between the sleeve and the bush and which seals the bush relative to the second tube.

This latter embodiment can have the feature that the coupling means comprise a screw thread present on the sleeve and a screw thread present on the bush co-acting therewith.

In yet another variant, this coupling can have the special feature that the coupling means comprise snap means, comprising at least one protrusion and a recess co-acting therewith, one of which is present on the sleeve and the other on the bush.

In a specific embodiment, the coupling according to the invention has the special feature that the bush comprises an axial stop which defines the extreme axial position of the first body and/or of the second body. Using this embodiment the coupling can be effected in very simple manner by inserting the cylindrical end zone of the second body with some axial force into the cylindrical hole in the first body, wherein the axial insertion distance is determined by said axial stop. This axial stop can for instance be embodied as an annular shoulder, against which the leading edge of the end zone of the second body comes to lie.

According to a determined aspect of the invention, the coupling has the special feature that the first body is a tube or tube stub.

A coupling according to the invention can for instance be applied for the coupling of two tubes. A two-sided coupling sleeve can thus for instance be coupled at both its ends to respective tubes by means of two associated rings. Such a sleeve can optionally be an outer sleeve or an inner sleeve. In the case of an outer sleeve, the connection between the tubes for coupling to each other can be realized such that these tubes come to rest with their free end edges against each other. A completely medium-tight sealing can further be ensured by making use of suitable sealing means, for instance sealing rings present on the inner surface of the outer sleeve.

The invention is not only suitable for coupling tubes but in general for coupling a body provided with a hole to another body having at least a cylindrical end zone, for instance a solid rod. The coupling according to the invention can thus serve to place an outside letterbox on a for instance wooden post. Table legs can also be connected to a tabletop provided with holes using the coupling according to the invention. A hammerhead provided with a suitable hole can also be connected to a handle with the coupling according to the invention.

The given examples are not limitative and serve only as an indication of possible applications of the invention. What is important is that an established coupling cannot be released by exerting only an axial tensile force on the two bodies. The connection by means of the coupling according to the invention can only be released by mutually rotating the bodies in the above described manner.

The invention will now be elucidated on the basis of the accompanying drawings.

In the drawings:

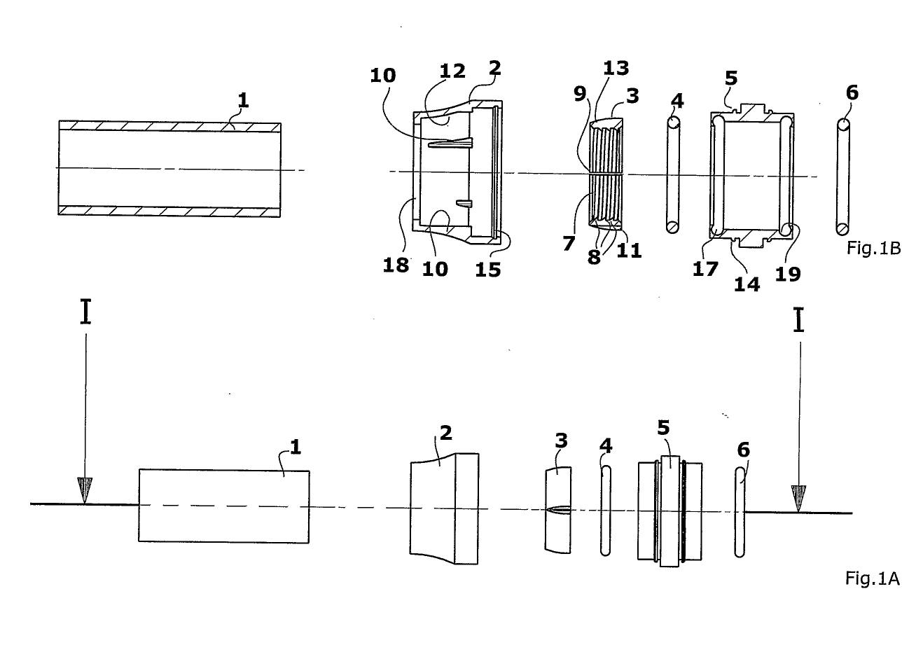

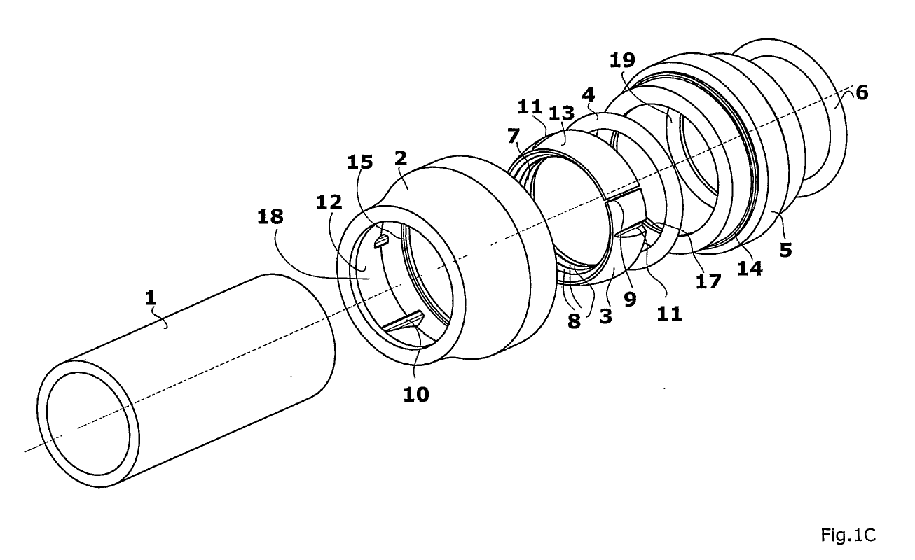

FIG. 1A shows an exploded side view of a coupling according to the invention in a first embodiment;

FIG. 1B shows a cross-section corresponding with FIG. 1A;

FIG. 1C is a perspective view corresponding with FIGS. 1A and 1B;

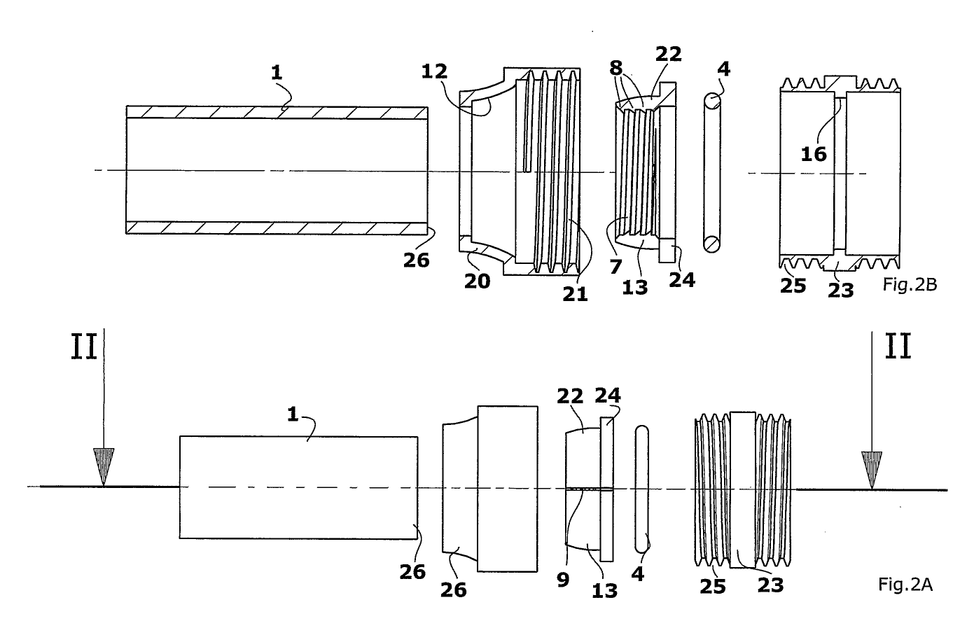

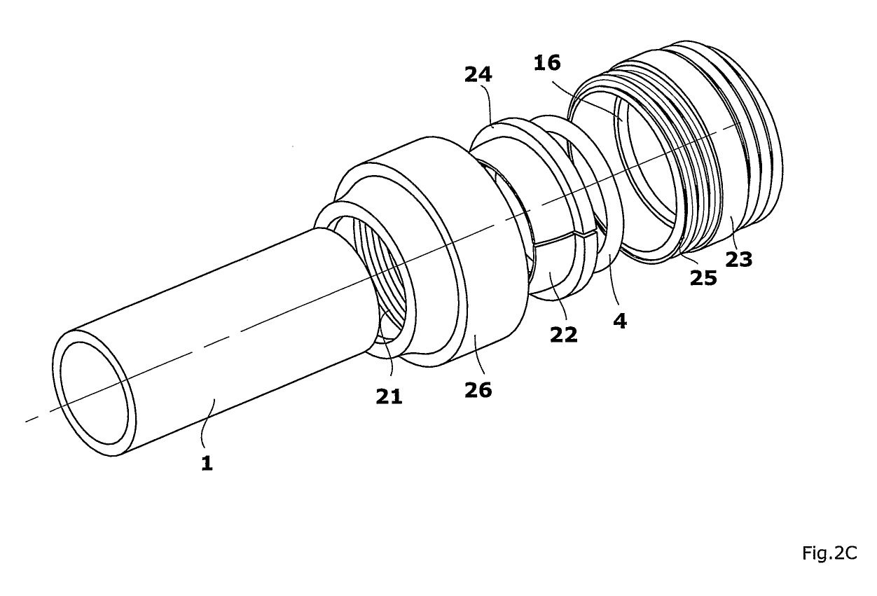

FIG. 2A shows an exploded side view of a coupling according to the invention in a second embodiment;

FIG. 2B shows a cross-section corresponding to FIG. 2A; and

FIG. 2C is a perspective view corresponding with FIGS. 2A and 2B.

FIGS. 1A, 1B and 1C show a first embodiment of the coupling according to the invention in three mutually corresponding exploded views.

Coupling 1 comprises a first body, embodied as a bush 5, a second body embodied as tube 1, a sleeve 2, a cutting ring 3 with tongues 8 and first sealing ring 4.

Prior to effecting the coupling between tube 1 and bush 5 the first sealing ring 4 is first arranged in an annular recess 17 intended for this purpose. Sleeve 2 is then arranged in snapping manner on bush 5 while enclosing cutting ring 3. The snap connection is brought about by the co-action between an annular external snap edge 14 on bush 5 and an internal recess 15 corresponding therewith in sleeve 2.

The first sealing ring 4 has a diameter such that tube 1 can pass it with a certain elastic deformation, thereby bringing about an effective sealing.

As tube 1 is inserted into the deformed unit 2, 3, 4, 5 via access opening 18 of sleeve 2, tube 1 passes the cutting ring 3. This has a number of tongues 15 arranged on the inner side which are embodied as the windings of a helix 7. As shown particularly in FIG. 1B, the main direction of the tongues has a substantial component in the direction of arrangement. The protruding end edges of tongues 8 are defined by the side surfaces of these tongues. These enclose acute mutual angles, in this embodiment angles with a value in the order of 60°. Owing to this inclining position of the tongues directed to the right in the drawing, tube 1 which is plastically deformable by the tongues can pass them while making scraping contact. Cutting ring 3 is then forced to expand. This is possible due to the presence of an interruption 9 which imparts a certain compressibility and expandability to ring 3. Both properties are important. After all, when being inserted into cutting ring 3 the tube 1, which has a greater diameter than the imaginary cylinder defined by the tops of tongues 8, must press these tongues apart. The cutting ring expands and the tube, moving to the right in the figure, can be pushed through cutting ring 3, wherein the end edges of tongues 8 scrape over the outer surface of tube 1. This displacement must be continued over an appropriate distance, in any case beyond the first sealing ring 4.

The backward movement is blocked by said inclining position of the tongues. Insofar as this bracing action is not wholly sufficient under certain conditions, this bracing action is enhanced by the co-action between the tapering inner surface 12 of sleeve 2 and the tapering outer surface 13 of cutting ring 3. At an attempted backward displacement the forces exerted on the cutting ring by surface 12 ensure that cutting ring 3 will tend to compress, whereby the forces exerted on the tube by the end edges of tongues 8 increase, this more or less in proportion to the tensile force applied.

It will hereby be apparent that it is impossible to remove tube 1 from combination 2, 3, 4, 5 by an axial backward displacement.

The only possibility of doing so is relative rotation of the tube relative to said combination, whereby tongues 8 as it were cut a screw thread into the outer surface of tube 1, which is thereby damaged plastically but is not lost. A removed tube 1 can be inserted again, whereafter the coupling is once again effected. It is important that the first sealing ring 4 is located downstream relative to cutting ring 3 in the insertion direction. This latter does after all damage the outer surface of tube 1, and this damaged outer surface could form a seal with the first sealing ring which in certain conditions is not ideal.

It is of great importance to ensure that cutting ring 3 cannot rotate relative to sleeve 2. For this purpose the inner surface 12 has ribs 10 extending in axial direction, which co-act with axially extending recesses 11 in the outer surface of ring 3. In this manner rotation of tube 1 relative to cutting ring 3 is prevented. The rotating forces for removing tube 1 must therefore be exerted between this tube 1 and sleeve 2. One of the two can be rotated as desired.

In this embodiment, in which sleeve 2 and bush 5 are mutually connected with the described snap connection, sleeve 2 could be rotated and be provided for this purpose on the outside with for instance a non-round shape, so that it can for instance be rotated relative to tube 1 using a suitable tool. During this rotation tube 1 is displaced gradually outward until it is out of engagement with tongues B.

FIG. 1 shows that bush 5 takes a symmetrical form. It thus has a second recess 19 in which a second sealing ring 6 can be accommodated. Not drawn because of the scale of the drawing is that on the right-hand side of the bush use can also be made of a second cutting ring, a second sleeve and a second tube. This structure therefore effectively comprises two couplings of the type according to the invention.

Cutting ring 3 can for instance consist of metal, such as aluminium or steel, or be embodied in plastic, for instance POM or ABS. Tube 1 can consist of PVC or another material which can co-act in the described manner with cutting ring 3.

Attention is drawn to the fact that the exemplary embodiment according to FIG. 1C could also be modified in the sense that bush 5 can be fixedly connected to or can form part of a tube, so that only one coupling of the invention as according to FIG. 1 is required. The coupling according to FIG. 1B is however more universal and makes it possible to mutually connect unfinished tubes brought to size as required.

Attention is further drawn to the fact that the tubes to be mutually coupled do not necessarily have to have the same diameters. Bush 5 can thus be embodied such that it can accommodate tubes of different diameters on both sides. In that case the non-deformed diameter of the relevant sealing ring 6, the relevant cutting ring and the relevant sleeve are of course adjusted accordingly.

FIG. 2 shows a variant in which, in contrast to the embodiment of FIG. 1, a sleeve 20 is connected to a bush 23 by means of screw thread 21 which is present in the interior of the sleeve and which co-acts with external screw thread 25 present on the outer side of a bush 23.

In this embodiment the first sealing ring 4 is not accommodated in a recess as in FIG. 1, but is enclosed between the mouth rim 26 of tube 1 and an annular shoulder 16 serving as axial stop inside bush 23.

A cutting ring 22 is placed inside sleeve 20 in the manner shown in FIG. 2, the first sealing ring 4 is placed between bush 23 and cutting ring 22, whereafter sleeve 20 is screwed onto bush 23.

In contrast to cutting ring 3, cutting ring 22 has a flanged edge 24.

It is noted that in the embodiment according to FIG. 2 no use is made of specific provisions which lock cutting ring 22 against rotation other than by friction. In this embodiment is ensured that the frictional forces exerted on cutting ring 22 are sufficiently large to ensure that no unintended rotation of cutting ring 22 occurs when tube 1 is removed by rotation. In this case it is not necessary to make use of the ribs and corresponding recesses as are applied in the embodiment according to FIG. 1. Should it be found during testing for instance that an unintended rotation occurs with the choice of a specific material, whereby tube 1 cannot be removed according to the invention, or only with difficulty, use can then be made of the rotation locking means described with reference to FIG. 1. Use can also be made of a glue connection if desired. In that case it is necessary to ensure that the deformability of the cutting ring required according to the invention is not essentially affected.

Just as FIGS. 1A, 1B and 1C, FIGS. 2A, 2B and 2C show only a part of a coupling between two tubes. Not drawn is that on the right-hand side of bush 23 there is situated the same structure as on the left-hand side, i.e. a sealing ring, a cutting ring, a sleeve and a second tube.

As also noted with reference to the first exemplary embodiment, the tube can also already be provided in this embodiment with a bush 23 with external screw thread 25.

Use can also be made of tubes to be mutually coupled which have different diameters.

It is noted that the two drawn exemplary embodiments make use of a structure wherein the cutting ring is provided with an internal helix. The invention however also relates to a structure wherein use is made of a cutting ring with an external helix.

1. A coupling in between a first body with a hole, for instance a cylindrical hole with an axis, and a cylindrical end zone of a second body to be inserted therein in an axial insertion direction, in which hole and/or on the surface of which end zone extend a number of elastically displaceable tongues connected to the relevant body, the free end edges of which tongues lie substantially on the peripheral plane of an imaginary, substantially rotation-symmetrical body, respectively the diameter of which is smaller than the outer diameter of the end zone of the second body or the diameter of which is greater than the diameter of the hole, which tongues deform elastically when said end zone is arranged and scrape over the surface thereof with their free edges such that after arranging of the end zone over some distance the movement in backward direction relative to the insertion direction is blocked, wherein:
the tongues form part of a ring;
the tongues are the windings of a protruding helix;
the main direction of the tongues has a substantial component in the direction of arrangement;
the protruding end edges of the tongues are defined by the side surfaces of those tongues, which side surfaces enclose an acute angle with each other;
the ring co-acts with a sleeve which is connected to the first body and defines the axial position of the ring;
the ring has an interruption wherein the end surfaces adjacent thereto are displaceable relative to each other during elastic deformation of the ring;
the helix has a diameter such that, during arranging, the end zone of the second body can be displaced along the helix only during elastic deformation of the ring, and the end edges of the tongues exert elastic pressure forces on the end zone of the second body;
the ring is locked against rotation relative to the first body by locking means; and
pressing means are present which are connected to the first body and cause additional pressure forces between the end edges of the tongues and the end zone of the second body in the case where a force in opposite direction to the insertion direction is excited between the ring and the second body;
this such that, when the second body rotates around the axis relative to the first body, the helix is followed in that the tongues cut into the surface of the end zone, so that an axial relative movement also occurs and said end zone of the second body can be removed from the first body.

2. The coupling as claimed in claim 1, wherein the ring consists of metal, for instance steel or aluminium.

3. The coupling as claimed in claim 1, wherein the ring consists of plastic, for instance ABS or POM.

4. The coupling as claimed in claim 1, wherein at least said end zone of the second body consists of plastic, concrete, wood or metal, such as iron, copper or aluminium.

5. The coupling as claimed in claim 1, wherein the pressing means comprise a substantially rotation-symmetrical pressure surface which forms part of the sleeve and co-acts with the ring, and which has a diameter varying monotonously in axial direction, for instance roughly corresponding to the shape of a truncated cone, which pressure surface elastically deforms the ring during the exertion of said force in opposite direction to the insertion direction between the ring and the second body such that the pressure forces exerted on the second body by the ribs are increased.

6. The coupling as claimed in claim 1, wherein the locking means have at least one protrusion and a recess co-acting therewith, one of which is present on the ring and the other on the sleeve.

7. The coupling as claimed in claim 1, comprising a bush which can be coupled to the sleeve by means of coupling means, and a sealing ring which is present in the transition zone between the sleeve and the bush and which seals the bush relative to the second tube.

8. The coupling as claimed in claim 7, wherein the coupling means comprise a screw thread present on the sleeve and a screw thread present on the bush co-acting therewith.

9. The coupling as claimed in claim 7, wherein the coupling means comprise snap means, comprising at least one protrusion and a recess co-acting therewith, one of which is present on the sleeve and the other on the bush.

10. The coupling as claimed in claim 7, wherein the bush comprises an axial stop which defines the extreme axial position of the first body and/or of the second body.

11. The coupling as claimed in claim 1, wherein the first body is a tube or tube stub.
